(19) United States
(12) Patent Application Publication
(10) Pub. No.: US 2026/0168052 A1
(43) Pub. Date: Jun. 18, 2026

(54) METHOD FOR MANUFACTURING MEDIUM- ENTROPY ALLOYS USING ADDITIVE MANUFACTURING

(71) Applicant: POSTECH RESEARCH AND BUSINESS DEVELOPMENT FOUNDATION, Pohang-si (KR)

(72) Inventors: Hyoung Seop KIM, Pohang-si (KR); Ji Yeong LEE, Pohang-si (KR); Jae Heung LEE, Pohang-si (KR); Bon Woo KOO, Pohang-si (KR); Dae Kyeom KIM, Cheonan-si (KR)

(21) Appl. No.: 19/185,514

(22) Filed: Apr. 22, 2025

(30) Foreign Application Priority Data
Dec. 13, 2024 (KR) 10-2024-0185759

(51) Int. Cl. C22C 1/04; B22F 10/28; B33Y 10/00; B33Y 80/00; C22C 33/02; C22C 38/22; C22C 38/30

(52) U.S. Cl. CPC C22C 1/04; B22F 10/28; B33Y 10/00; B33Y 80/00; C22C 33/0207; C22C 38/22; C22C 38/30; B22F 2301/35; B22F 2998/10; B22F 2999/00

(57) ABSTRACT

The invention provides a method for manufacturing a medium-entropy alloy product having various compositions through additive manufacturing. To achieve the task described above, in a method for manufacturing a medium-entropy alloy through additive manufacturing according to the invention, the additive manufacturing is performed by spraying and heating two or more alloy powders having different compositions, the alloy powders include two or more alloy elements, and a difference in melting points between the two or more alloy powders is 400° C. or less.

### BACKGROUND OF THE INVENTION

### 1. Field of the Invention

The present invention relates to a method for manufacturing a medium-entropy alloy through additive manufacturing of powders, and more particularly, to a method for manufacturing a medium-entropy alloy through additive manufacturing in which plural alloy powders are used and a melting point between these alloy powders is 400° C. or less.

### 2. Description of the Related Art

While various alloys have been developed in response to the advancement of industrial technology, high-entropy alloys, which have recently been proposed as a new alloy system, are being developed.

Unlike typical alloys, which are made by adding small amounts of auxiliary elements to a main element, high-entropy alloys are made by mixing five or more elements, all of which are provided as main elements, in similar proportions, and are structured as face centered cubic (FCC) or body centered cubic (BCC) without forming intermetallic compounds due to high configurational entropy despite the mixing of main elements.

Typically, alloys are classified into high-entropy alloys (HEAs), medium-entropy alloys (MEAs), and low-entropy alloys (LEAs) according to the magnitude of the configurational entropy (ΔS_{conf}) based on the composition of alloy elements, and this classification is determined by the following formula conditions.

$${ΔS}_{conf} ( LEAs ) < 1. \cdot R \qquad [ Formula 1 ]$$

$$1. \cdot R \leq Δ {S}_{conf} ( MEAs ) < 1.5 \cdot R \qquad [ Formula 2 ]$$

$$1.5 \cdot R \leq Δ {S}_{conf} \qquad [ Formula 3 ]$$

### (R: Gas Constant)

Typically, the development of high-entropy alloys with the same atomic composition has been actively pursued. However, recently, various medium-entropy alloys exhibiting excellent mechanical properties and being applicable to extreme environments such as cryogenic or corrosive environments are being developed.

While research and development is continuously being conducted to further improve desired physical properties by varying the composition, typical casting methods are time-consuming and costly for screening a wide range of compositions.

### SUMMARY OF THE INVENTION

The invention provides a method for manufacturing a medium-entropy alloy product having various compositions through additive manufacturing.

According to an embodiment of the invention, there is provided a method for manufacturing a medium-entropy alloy through additive manufacturing. In the method, the additive manufacturing is performed by spraying and heating two or more alloy powders having different compositions, the alloy powders include two or more alloy elements, and a difference between a maximum melting point and a minimum melting point among melting points of each of the two or more alloy powders is 400° C. or less.

In addition, in an embodiment of the method for manufacturing a medium-entropy alloy according to the invention, the difference between the maximum melting point and the minimum melting point is 120° C. or less.

In addition, in an embodiment of the method for manufacturing a medium-entropy alloy according to the invention, the medium-entropy alloy may include 44 to 60.9 atomic % of Fe, 9.3 to 24 atomic % of Co, 4.3 to 23.5 atomic % of Cr, 3.9 to 22.5 atomic % of Ni, 0.9 to 8.4 atomic % of Mo, and other inevitable impurities.

In addition, in an embodiment of the method for manufacturing a medium-entropy alloy according to the invention, the two or more alloy powders may include first to third alloy powders, the first alloy powder may include Fe, Co, and Mo, the second alloy powder may include Fe, Cr, and Ni, and the third alloy powder may include Fe, Co, and Cr.

In addition, in an embodiment of the method for manufacturing a medium-entropy alloy according to the invention, the first alloy powder has a melting point of 1,400 to 1,420° C., the second alloy powder has a melting point of 1,390 to 1,410° C., and the third alloy powder has a melting point of 1,490 to 1,510° C.

In addition, in an embodiment of the method for manufacturing a medium-entropy alloy according to the invention, the heating may be performed via laser or electron beam.

### BRIEF DESCRIPTION OF THE DRAWINGS

FIG. 1 is a scanning electron microscope image of an alloy powder according to an embodiment of the invention;

FIG. 2 is a schematic view describing a method for manufacturing medium-entropy alloy according to an embodiment of the invention;

FIG. 3 is a triangular diagram illustrating compositions of embodiments of the invention;

FIG. 4 is an image of an alloy product according to embodiments of the invention;

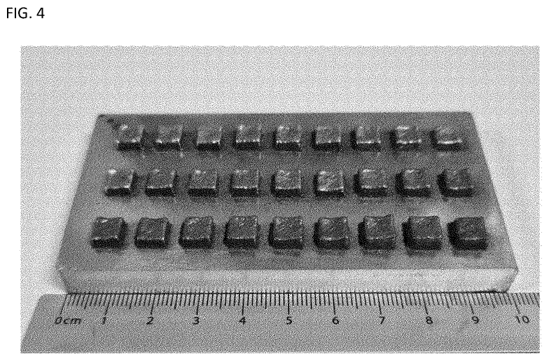

FIG. 5 is a graph illustrating a comparison between a target composition and an actual measured composition of embodiments of the invention;

FIG. 6 illustrates the results of X-ray diffraction analysis for embodiments of the invention; and

FIG. 7 is a graph illustrating the hardness and crystal structure distribution by composition of embodiments of the invention.

### DETAILED DESCRIPTION OF THE EXEMPLARY EMBODIMENTS

Embodiments of the invention will be described in detail with reference to the accompanying drawings to the extent that those skilled in the art may readily practice. However, the invention may be embodied in many different forms and should not be construed as limited to the embodiments set forth herein.

Throughout the description, when an element “includes” a component, it may indicate that the element does not exclude another component unless explicitly described to the contrary, but can further include another component.

The terms “about”, substantially”, and the like used throughout the description indicates that when a natural manufacturing and a substance allowable error are suggested, such an allowable error corresponds the value or is similar to the value, and such values are intended for the sake of clear understanding of the invention or to prevent an unconscious infringer from illegally using the disclosure of the invention. In addition, through the description, the terms “step wherein” or “step of” does not indicate “step for”.

Through the description, the term “combination thereof” included in an expression of a Markush form means a mixture or combination of one or more elements selected from the group consisting of the elements in the expression of the Markush form, and thereby means that at least one selected from a group consisting of the elements is included.

Throughout the description, the description of “A and/or B” indicates “A or B, or A and B”.

A method for manufacturing a medium-entropy alloy according to the invention is performed through additive manufacturing, the additive manufacturing is performed by spraying and heating plural alloy powders having different compositions, the plural alloy powders include two or more alloy elements, and a difference in melting points between the two or more alloy powders is 400° C. or less.

The additive manufacturing enables the production of complex shapes and internal structures that are difficult to achieve through typical manufacturing methods in the manufacture of metal products, is suitable for small-scale production of a variety of products, and allows for rapid prototyping and verification.

For the additive manufacturing of metal products, metal powder additive manufacturing, which is performed by spraying and heating metal powder, is a primary manufacturing method. The metal powder is partially melted through heating, resulting in bonding. In this case, concentrated energy sources such as lasers or electron are primarily used for heating. Powder Bed Fusion (PBF) and Directed Energy Deposition (DED) are typical metal powder additive manufacturing methods, with the PBF method being the predominant method.

While it is not difficult to produce metal products of a single composition using these metal powder additive manufacturing methods, producing metal products made of alloys with various combined elements results in non-uniform compositions and many defects due to a differences in melting points between metal elements. In the past, to control the alloy composition, metal powders of a single element were combined and subjected to additive manufacturing, and accordingly, even when the same energy is applied, some powders melt while others do not, resulting in a lack of uniform composition throughout the product.

In particular, this issue may become more severe when using metal powders with high melting points, such as high-entropy alloys or medium-entropy alloys. For example, Fe, a major element in iron-based medium-entropy alloys, has a melting point of 1,538° C., while Cr and Mo, other major elements, have a melting point of 1,907° C. and 2, 623° C., respectively, showing a very large difference in melting points. When these element powders are simply mixed and subjected to additive manufacturing, the Fe powder melts and flows excessively, while Cr and Mo do not melt, resulting in a non-uniform composition and many defects.

In addition, there is a method of first casting a target alloy composition and then making the target alloy composition into powder to perform printing with a single composition alloy powder, but in this case, it is difficult to produce products with various compositions. When it comes to producing alloy powder, it is supposed to be a large quantity, and when an alloy product is made from only one type of alloy powder produced in this way, varying the composition is not achievable.

To overcome the limitation above, the invention uses plural alloy powders as metal powders and induces these alloy powders to have melting points within a similar range, thereby maintaining a uniform composition in the additive manufacturing. This allows for the uniform melting of various elements with significant melting point differences. The melting point difference between the alloy powders being 400° C. or less indicates that a difference between a highest melting point and a lowest melting point among the alloy powders is 400° C. or less. This melting point difference may be preferably 400° C. or less, more preferably 200° C. or less, and even more preferably 120° C. or less.

This method may be highly desirable in a medium-entropy alloy containing a metal element having a high melting point, through which a medium-entropy alloy containing Fe, Co, Cr, Ni, Mo, and inevitable impurities may be manufactured.

This medium-entropy alloy, having excellent mechanical properties, may be used in cryogenic or corrosive environments. In particular, in iron-based medium entropy alloys, Cr and Mo having high melting points are used, and thus, for additive manufacturing using these alloys, the additive manufacturing method according to the invention, which makes the melting point of the raw material powder uniform, is desirable.

A medium-entropy alloy of this composition may include 44 to 60.9 atomic % of Fe, 9.3 to 24 atomic % of Co, 4.3 to 23.5 atomic % of Cr, 3.9 to 22.5 atomic % of Ni, 0.9 to 8.4 atomic % of Mo, and other inevitable impurities. By optimizing the composition of Fe, Co, Cr, Ni, and Mo as described above through the additive manufacturing method according to the excellent mechanical invention, properties and high corrosion resistance may be achieved.

To achieve this alloy powder having a uniform melting point, in the additive manufacturing method according to the invention, the alloy powder may include first to third alloy powders, the first alloy powder may include Fe, Co, and Mo, the second alloy powder may include Fe, Cr, and Ni, and the third alloy powder may include Fe, Co, and Cr. Through these combinations, the melting point difference between the alloy powders may be adjusted to 400° C. or less.

In particular, the first alloy powder including Fe, Co, and Mo may have a melting point of 1,400 to 1,420° C., the second alloy powder including Fe, Cr, and Ni may have a melting point of 1,390 to 1,410° C., and the third alloy powder including Fe, Co, and Cr may have a melting point of 1,490 to 1,510° C.

The medium-entropy alloy produced through the additive manufacturing method according to the invention has a Vickers hardness of 170 to 410 Hᵥ.

The following describes Examples of a medium-entropy alloy produced through the additive manufacturing method according to the invention.

### EXAMPLES

In the invention, to ensure good alloying by considering a difference in melting points, three different alloy powders containing major elements, rather than element powders, were used.

First powder: Fe—Co—Mo, Second powder: Fe—Cr—Ni, Third powder: Fe—Co—Cr

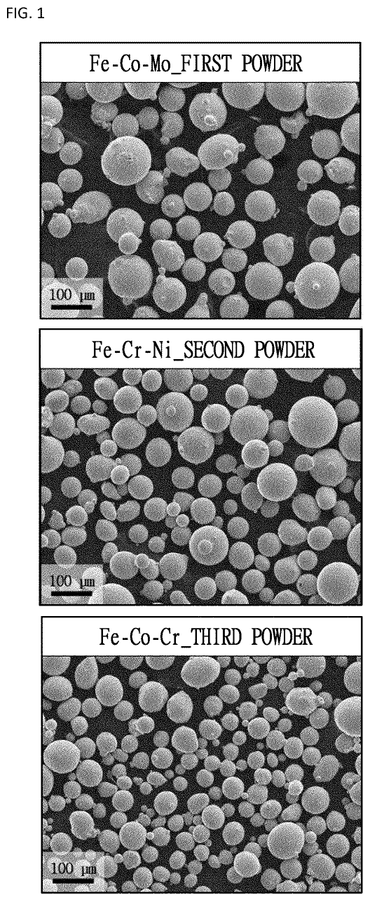

Referring to FIG. 1, FIG. 1 illustrates the form of powders used and the composition of each element. To prevent clogging of a nozzle unit where each powder is sprayed during additive manufacturing, re-classification was performed after cross-verification performed to see if a ratio of fine powder was small through particle size analysis. Table 1 below shows the composition ranges of the three powders in atomic %.

TABLE 1

| | First powder | Second powder | Third powder |
|---|---|---|---|
| Fe | 65.27 ± 0.04 | 33.90 ± 0.19 | 61.27 ± 0.16 |
| Co | 24.73 ± 0.18 | — | 31.33 ± 0.11 |
| Cr | — | 33.27 ± 0.16 | 7.40 ± 0.12 |
| Ni | — | 33.83 ± 0.04 | — |
| Mo | 10.0 ± 0.14 | — | |

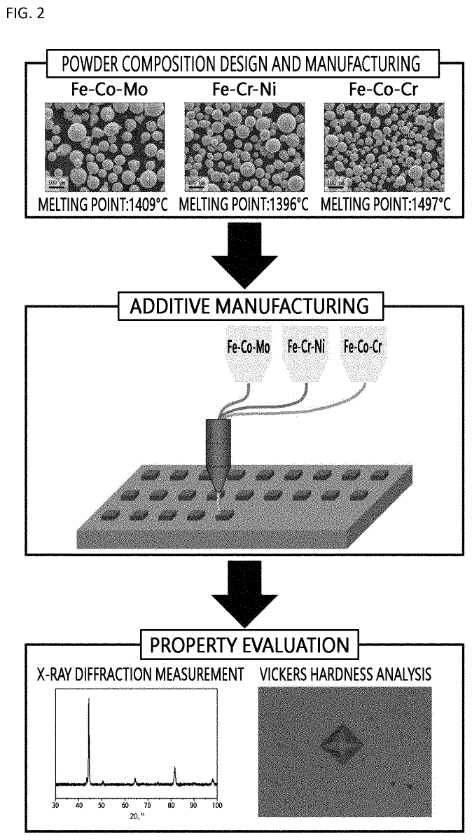

Referring to FIG. 2, FIG. 2 schematically illustrates the process of in-situ alloying, where three types of powder are supplied together and in-situ alloyed by laser focusing.

During 3D printing, a supply amount of each powder was as follows: 20 to 80% for a first powder, 10 to 60% for a second powder, and 10 to 50% for a third powder, with respect to weight.

Each time additive manufacturing was performed on 27 coupons, each having a three-dimensional shape, a spray amount from each nozzle unit was varied to change the supply amount of each powder, resulting in different compositions for each of the 27 coupons.

The supply amount of each powder was varied, and the spray amount from each nozzle unit was changed each time additive manufacturing was performed by a layer.

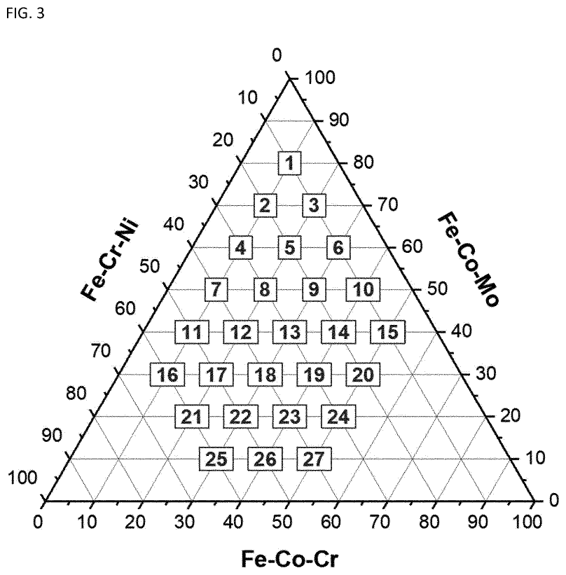

Composition ratios of the powders supplied to each of the 27 coupons are shown in FIG. 3.

Instead of typical methods of casting an alloy first and then making the alloy into powder for printing, this method allows for the production of alloy products with a wide range of compositions by combining three types of powder containing main elements to match the desired alloy composition and then performing printing.

The composition range was set considering that when the Fe element exceeds 62.0 atomic %, the stability of the FCC phase excessively decreases, resulting in a significant decrease in ductility, and when the Fe element is less than 44.0 atomic %, the stability of the FCC phase excessively increases, simplifying deformation mechanism.

The composition range was set considering that when the Co element exceeds 26.0 atomic %, the stability of the FCC phase excessively decreases, resulting in significant decrease in ductility, and when the Co element is less than 9.0 atomic %, strength is impaired due to a decrease in lattice distortion.

The composition range was set considering that when the Cr element exceeds 24.0 atomic %, a precipitation phase that causes brittleness occurs, resulting in a significant decrease in ductility, and when the Cr element is less than 4.0 atomic %, strength is impaired due to a decrease in lattice distortion.

The composition range was set considering that when the Ni element exceeds 24.0 atomic %, the stability of the FCC phase excessively increases, simplifying deformation mechanism, and when the Ni element is less than 3.5 atomic %, the stability of the FCC phase excessively decreases, resulting in a significant decrease in ductility.

The composition range was set considering that when the Mo element exceeds 8.5 atomics, excessive precipitation caused, resulting in a significant decrease in ductility, and when the Mo element is less than 0.5 atomic %, strength is impaired due to a decrease in lattice distortion.

After manufacturing alloy powder, in the additive manufacturing the alloy powder produced in the powder manufacturing stage was sprayed, while the powder was melted by laser focusing to perform alloying. The printing conditions were as follows: an argon atmosphere, a powder feed rate of 3.0 g/min, a laser power of 225 W, a scan speed of 750 mm/min, and a zigzag pattern with a rotation angle of 67 degrees per layer to minimize thermal history for additive manufacturing, thereby manufacturing 27 coupons each measuring 6 mm in width and length and having a stack of 15 layers.

Lastly, in a material property evaluation stage, the properties of the 27 coupons manufactured in the additive manufacturing stage were evaluated. For property evaluation, microstructure analysis was performed through X-ray diffraction experiments, and Vickers hardness was measured.

### Example 1

Supply amounts of a first powder, a second powder, and a third powder were adjusted to ratios of 80%, 10%, and 10%, respectively, to manufacture a coupon through in-situ alloying.

A target composition before printing was set to Fe: 61.4 atomic %, Co: 22.8 atomic %, Cr: 4.3 atomic %, Ni: 3.6 atomic %, and Mo: 7.9 atomic %.

An actual coupon composition after printing was found to be Fe: 60.9 atomic %, Co: 22.5 atomic %, Cr: 4.3 atomic %, Ni: 3.9 atomic %, and Mo: 8.4 atomic %.

A difference between the target composition and the actual composition was Fe: 0.5 atomic %, Co: 0.3 atomic %, Cr: 0 atomic %, Ni: 0.3 atomic %, and Mo: 0.5 atomic %, with almost no error to perform in-situ alloying.

### Example 2

Supply amounts of a first powder, a second powder, and a third powder were adjusted to ratios of 70%, 20%, and 10%, respectively, to manufacture a coupon through in-situ alloying.

A target composition before printing was set to Fe: 58.1 atomic %, Co: 20.2 atomic %, Cr: 7.8 atomic %, Ni: 7.1 atomic %, and Mo: 6.8 atomic %.

An actual coupon composition after printing was found to be Fe: 57.2 atomic %, Co: 19.4 atomic %, Cr: 8.0 atomic %, Ni: 7.8 atomic %, and Mo: 7.6 atomic %.

A difference between the target composition and the actual composition was Fe: 0.9 atomic %, Co: 0.8 atomic %, Cr: 0.2 atomic %, Ni: 0.7 atomic %, and Mo: 0.8 atomic %, with almost no error to perform in-situ alloying.

### Example 3

Supply amounts of a first powder, a second powder, and a third powder were adjusted to ratios of 70%, 10%, and 20%, respectively, to manufacture a coupon through in-situ alloying.

A target composition before printing was set to Fe: 61.1 atomic %, Co: 23.5 atomic %, Cr: 5.1 atomic %, Ni: 3.6 atomic %, and Mo: 6.8 atomic %.

An actual coupon composition after printing was found to be Fe: 60.2 atomic %, Co: 22.6 atomic %, Cr: 5.1 atomic %, Ni: 4.3 atomic %, and Mo: 7.7 atomic %.

A difference between the target composition and the actual composition was Fe: 0.9 atomic %, Co: 0.9 atomic %, Cr: 0 atomic %, Ni: 0.7 atomic %, and Mo: 0.9 atomic %, with almost no error to perform in-situ alloying.

### Example 4

Supply amounts of a first powder, a second powder, and a third powder were adjusted to ratios of 60%, 30%, and 10%, respectively, to manufacture a coupon through in-situ alloying.

A target composition before printing was set to Fe: 54.8 atomic %, Co: 17.6 atomic %, Cr: 11.2 atomic %, Ni: 10.6 atomic %, and Mo: 5.8 atomic %.

An actual coupon composition after printing was found to be Fe: 53.9 atomic %, Co: 16.8 atomic %, Cr: 11.7 atomic %, Ni: 11.5 atomic %, and Mo: 6.0 atomic %.

A difference between the target composition and the actual composition was Fe: 0.9 atomic %, Co: 0.8 atomic %, Cr: 0.5 atomic %, Ni: 0.9 atomic %, and Mo: 0.2 atomic %, with almost no error to perform in-situ alloying.

### Example 5

Supply amounts of a first powder, a second powder, and a third powder were adjusted to ratios of 60%, 20%, and 20%, respectively, to manufacture a coupon through in-situ alloying.

A target composition before printing was set to Fe: 57.7 atomic %, Co: 20.9 atomic %, Cr: 8.5 atomic %, Ni: 7.1 atomic %, and Mo: 5.8 atomic %.

An actual coupon composition after printing was found to be Fe: 56.7 atomic %, Co: 19.8 atomic %, Cr: 9.0 atomic %, Ni: 8.3 atomic %, and Mo: 6.2 atomic %.

A difference between the target composition and the actual composition was Fe: 1.0 atomic %, Co: 1.1 atomic %, Cr: 0.5 atomic %, Ni: 0.8 atomic %, and Mo: 0.4 atomic %, with almost no error to perform in-situ alloying.

### Example 6

Supply amounts of a first powder, a second powder, and a third powder were adjusted to ratios of 60%, 10%, and 30%, respectively, to manufacture a coupon through in-situ alloying.

A target composition before printing was set to Fe: 60.7 atomic %, Co: 24.2 atomic %, Cr: 5.8 atomic %, Ni: 3.5 atomic %, and Mo: 5.8 atomic %.

An actual coupon composition after printing was found to be Fe: 59.7 atomic %, Co: 22.8 atomic %, Cr: 6.1 atomic %, Ni: 4.8 atomic %, and Mo: 6.6 atomic %.

A difference between the target composition and the actual composition was Fe: 1.0 atomic %, Co: 1.4 atomic %, Cr: 0.3 atomic %, Ni: 1.3 atomic %, and Mo: 0.8 atomic %, with almost no error to perform in-situ alloying.

### Example 7

Supply amounts of a first powder, a second powder, and a third powder were adjusted to ratios of 50%, 40%, and 10%, respectively, to manufacture a coupon through in-situ alloying.

A target composition before printing was set to Fe: 51.6 atomic %, Co: 15.1 atomic %, Cr: 14.5 atomic %, Ni: 14.0 atomic %, and Mo: 4.8 atomic %.

An actual coupon composition after printing was found to be Fe: 52.9 atomic %, Co: 16.1 atomic %, Cr: 12.8 atomic %, Ni: 12.5 atomic %, and Mo: 5.6 atomic %.

A difference between the target composition and the actual composition was Fe: 1.3 atomic %, Co: 1.0 atomic %, Cr: 1.7 atomic %, Ni: 1.5 atomic %, and Mo: 0.8 atomic %, with almost no error to perform in-situ alloying.

### Example 8

Supply amounts of a first powder, a second powder, and a third powder were adjusted to ratios of 50%, 30%, and 20%, respectively, to manufacture a coupon through in-situ alloying.

A target composition before printing was set to Fe: 54.5 atomic %, Co: 18.3 atomic %, Cr: 11.9 atomic %, Ni: 10.5 atomic %, and Mo: 4.8 atomic %.

An actual coupon composition after printing was found to be Fe: 53.2 atomic %, Co: 16.7 atomic %, Cr: 12.7 atomic %, Ni: 12.2 atomic %, and Mo: 5.1 atomic %.

A difference between the target composition and the actual composition was Fe: 1.3 atomic %, Co: 1.6 atomic %, Cr: 0.8 atomic %, Ni: 1.7 atomic %, and Mo: 0.3 atomic %, with almost no error to perform in-situ alloying.

### Example 9

Supply amounts of a first powder, a second powder, and a third powder were adjusted to ratios of 50%, 20%, and 30%, respectively, to manufacture a coupon through in-situ alloying.

A target composition before printing was set to Fe: 57.4 atomic %, Co: 21.6 atomic %, Cr: 9.2 atomic %, Ni: 7.0 atomic %, and Mo: 4.8 atomic %.

An actual coupon composition after printing was found to be Fe: 56.6 atomic %, Co: 20.5 atomic %, Cr: 9.4 atomic %, Ni: 8.1 atomic %, and Mo: 5.4 atomic %.

A difference between the target composition and the actual composition was Fe: 0.8 atomic %, Co: 1.1 atomic %, Cr: 0.2 atomic %, Ni: 1.1 atomic %, and Mo: 0.6 atomic %, with almost no error to perform in-situ alloying.

### Example 10

Supply amounts of a first powder, a second powder, and a third powder were adjusted to ratios of 50%, 10%, and 40%, respectively, to manufacture a coupon through in-situ alloying.

A target composition before printing was set to Fe: 60.3 atomic %, Co: 24.9 atomic %, Cr: 6.5 atomic %, Ni: 3.5 atomic %, and Mo: 4.8 atomic %.

An actual coupon composition after printing was found to be Fe: 58.9 atomic %, Co: 22.9 atomic %, Cr: 7.3 atomic %, Ni: 5.4 atomic %, and Mo: 5.5 atomic %.

A difference between the target composition and the actual composition was Fe: 1.4 atomic %, Co: 2.0 atomic %, Cr: 0.8 atomic %, Ni: 1.9 atomic %, and Mo: 0.7 atomic %, with almost no error to perform in-situ alloying.

### Example 11

Supply amounts of a first powder, a second powder, and a third powder were adjusted to ratios of 40%, 50%, and 10%, respectively, to manufacture a coupon through in-situ alloying.

A target composition before printing was set to Fe: 48.4 atomic %, Co: 12.6 atomic %, Cr: 17.8 atomic %, Ni: 17.4 atomic %, and Mo: 3.8 atomic %.

An actual coupon composition after printing was found to be Fe: 48.4 atomic %, Co: 12.5 atomic %, Cr: 17.6 atomic %, Ni: 17.5 atomic %, and Mo: 4.0 atomic %.

A difference between the target composition and the actual composition was Fe: 0 atomic %, Co: 0.1 atomic, Cr: 0.2 atomic %, Ni: 0.1 atomic %, and Mo: 0.2 atomic %, with almost no error to perform in-situ alloying.

### Example 12

Supply amounts of a first powder, a second powder, and a third powder were adjusted to ratios of 40%, 40%, and 20%, respectively, to manufacture a coupon through in-situ alloying.

A target composition before printing was set to Fe: 51.3 atomic %, Co: 15.8 atomic %, Cr: 15.2 atomic %, Ni: 13.9 atomic %, and Mo: 3.8 atomic %.

An actual coupon composition after printing was found to be Fe: 50.2 atomic %, Co: 14.3 atomic %, Cr: 15.8 atomic %, Ni: 15.4 atomic %, and Mo: 4.2 atomic %.

A difference between the target composition and the actual composition was Fe: 1.1 atomic %, Co: 1.5 atomic %, Cr: 0.6 atomic %, Ni: 1.5 atomic %, and Mo: 0.4 atomic %, with almost no error to perform in-situ alloying.

### Example 13

Supply amounts of a first powder, a second powder, and a third powder were adjusted to ratios of 40%, 30%, and 30%, respectively, to manufacture a coupon through in-situ alloying.

A target composition before printing was set to Fe: 54.1 atomic %, Co: 19.0 atomic %, Cr: 12.6 atomic %, Ni: 10.5 atomic %, and Mo: 3.8 atomic %.

An actual coupon composition after printing was found to be Fe: 52.4 atomic %, Co: 17.3 atomic %, Cr: 13.9 atomic %, Ni: 12.6 atomic %, and Mo: 3.9 atomic %.

A difference between the target composition and the actual composition was Fe: 1.7 atomic %, Co: 1.7 atomic %, Cr: 1.3 atomic %, Ni: 2.1 atomic %, and Mo: 0.1 atomic %, with almost no error to perform in-situ alloying.

### Example 14

Supply amounts of a first powder, a second powder, and a third powder were adjusted to ratios of 40%, 20%, and 40%, respectively, to manufacture a coupon through in-situ alloying.

A target composition before printing was set to Fe: 57.0 atomic %, Co: 22.3 atomic %, Cr: 9.9 atomic %, Ni: 7.0 atomic %, and Mo: 3.8 atomic %.

An actual coupon composition after printing was found to be Fe: 54.5 atomic %, Co: 19.5 atomic %, Cr: 11.9 atomic %, Ni: 10.1 atomic %, and Mo: 4.0 atomic %.

A difference between the target composition and the actual composition was Fe: 2.5 atomics, Co: 2.8 atomic %, Cr: 2.0 atomic %, Ni: 3.1 atomic %, and Mo: 0.2 atomic %, with almost no error to perform in-situ alloying.

### Example 15

Supply amounts of a first powder, a second powder, and a third powder were adjusted to ratios of 40%, 10%, and 50%, respectively, to manufacture a coupon through in-situ alloying.

A target composition before printing was set to Fe: 59.9 atomic %, Co: 25.5 atomic %, Cr: 7.2 atomic %, Ni: 3.5 atomic %, and Mo: 3.8 atomic %.

An actual coupon composition after printing was found to be Fe: 58.8 atomic %, Co: 24.0 atomic %, Cr: 7.9 atomic %, Ni: 5.2 atomic %, and Mo: 4.0 atomic %.

A difference between the target composition and the actual composition was Fe: 1.1 atomic %, Co: 1.5 atomic %, Cr: 0.7 atomic %, Ni: 1.7 atomic %, and Mo: 0.2 atomic %, with almost no error to perform in-situ alloying.

### Example 16

Supply amounts of a first powder, a second powder, and a third powder were adjusted to ratios of 30%, 60%, and 10%, respectively, to manufacture a coupon through in-situ alloying.

A target composition before printing was set to Fe: 45.3 atomic %, Co: 10.1 atomic %, Cr: 21.1 atomic %, Ni: 20.7 atomic %, and Mo: 2.8 atomic %.

An actual coupon composition after printing was found to be Fe: 44.5 atomic %, Co: 9.3 atomic %, Cr: 21.7 atomic %, Ni: 21.7 atomic %, and Mo: 2.8 atomic %.

A difference between the target composition and the actual composition was Fe: 0.8 atomic %, Co: 0.8 atomic %, Cr: 0.6 atomic %, Ni: 1.0 atomic %, and Mo: 0 atomic %, with almost no error to perform in-situ alloying.

### Example 17

Supply amounts of a first powder, a second powder, and a third powder were adjusted to ratios of 30%, 50%, and 20%, respectively, to manufacture a coupon through in-situ alloying.

A target composition before printing was set to Fe: 48.1 atomic %, Co: 13.3 atomic %, Cr: 18.5 atomic %, Ni: 17.2 atomic %, and Mo: 2.8 atomic %.

An actual coupon composition after printing was found to be Fe: 46.7 atomic %, Co: 11.7 atomic %, Cr: 19.6 atomic %, Ni: 19.2 atomic %, and Mo: 2.9 atomic %.

A difference between the target composition and the actual composition was Fe: 1.4 atomic %, Co: 1.6 atomic %, Cr: 1.1 atomic %, Ni: 2.0 atomic %, and Mo: 0.1 atomic %, with almost no error to perform in-situ alloying.

### Example 18

Supply amounts of a first powder, a second powder, and a third powder were adjusted to ratios of 30%, 40%, and 30%, respectively, to manufacture a coupon through in-situ alloying.

A target composition before printing was set to Fe: 51.0 atomic %, Co: 16.5 atomic %, Cr: 15.8 atomic %, Ni: 13.8 atomic %, and Mo: 2.8 atomic %.

An actual coupon composition after printing was found to be Fe: 50.7 atomic %, Co: 16.1 atomic %, Cr: 15.8 atomic %, Ni: 14.3 atomic %, and Mo: 3.0 atomic %.

A difference between the target composition and the actual composition was Fe: 0.3 atomic %, Co: 0.4 atomic %, Cr: 0 atomic %, Ni: 0.5 atomic %, and Mo: 0.2 atomic %, with almost no error to perform in-situ alloying.

### Example 19

Supply amounts of a first powder, a second powder, and a third powder were adjusted to ratios of 30%, 30%, and 40%, respectively, to manufacture a coupon through in-situ alloying.

A target composition before printing was set to Fe: 53.8 atomic %, Co: 19.7 atomic %, Cr: 13.2 atomic %, Ni: 10.4 atomic %, and Mo: 2.8 atomic %.

An actual coupon composition after printing was found to be Fe: 50.8 atomic %, Co: 16.2 atomic %, Cr: 15.9 atomic %, Ni: 14.3 atomic %, and Mo: 2.9 atomic %.

A difference between the target composition and the actual composition was Fe: 3.0 atomic %, Co: 3.5 atomic %, Cr: 2.7 atomic %, Ni: 3.9 atomic %, and Mo: 0.1 atomic %, with almost no error to perform in-situ alloying.

### Example 20

Supply amounts of a first powder, a second powder, and a third powder were adjusted to ratios of 30%, 20%, and 50%, respectively, to manufacture a coupon through in-situ alloying.

A target composition before printing was set to Fe: 56.7 atomic %, Co: 23.0 atomic %, Cr: 10.6 atomic %, Ni: 6.9 atomic %, and Mo: 2.8 atomic %.

An actual coupon composition after printing was found to be Fe: 53.6 atomic %, Co: 19.4 atomic %, Cr: 13.2 atomic %, Ni: 11.0 atomic %, and Mo: 2.9 atomic %.

A difference between the target composition and the actual composition was Fe: 3.1 atomic %, Co: 3.6 atomic %, Cr: 2.6 atomic %, Ni: 4.1 atomic %, and Mo: 0.1 atomic %, with almost no error to perform in-situ alloying.

### Example 21

Supply amounts of a first powder, a second powder, and a third powder were adjusted to ratios of 20%, 60%, and 20%, respectively, to manufacture a coupon through in-situ alloying.

A target composition before printing was set to Fe: 45.1 atomic %, Co: 10.9 atomic %, Cr: 21.7 atomic %, Ni: 20.5 atomic %, and Mo: 1.9 atomic %.

An actual coupon composition after printing was found to be Fe: 44.0 atomic %, Co: 9.4 atomic %, Cr: 22.4 atomic %, Ni: 22.1 atomic %, and Mo: 2.1 atomic %.

A difference between the target composition and the actual composition was Fe: 1.1 atomic %, Co: 1.5 atomic %, Cr: 0.7 atomic %, Ni: 1.6 atomic %, and Mo: 0.2 atomic %, with almost no error to perform in-situ alloying.

### Example 22

Supply amounts of a first powder, a second powder, and a third powder were adjusted to ratios of 20%, 50%, and 30%, respectively, to manufacture a coupon through in-situ alloying.

A target composition before printing was set to Fe: 47.9 atomic %, Co: 14.1 atomic %, Cr: 19.1 atomic %, Ni: 17.1 atomic %, and Mo: 1.9 atomic %.

An actual coupon composition after printing was found to be Fe: 46.3 atomic %, Co: 12.2 atomic %, Cr: 20.5 atomic %, Ni: 19.2 atomic %, and Mo: 1.7 atomic %.

A difference between the target composition and the actual composition was Fe: 1.6 atomic %, Co: 1.9 atomic %, Cr: 1.4 atomic %, Ni: 2.1 atomic %, and Mo: 0.2 atomic %, with almost no error to perform in-situ alloying.

### Example 23

Supply amounts of a first powder, a second powder, and a third powder were adjusted to ratios of 20%, 40%, and 40%, respectively, to manufacture a coupon through in-situ alloying.

A target composition before printing was set to Fe: 50.7 atomic %, Co: 17.3 atomic %, Cr: 16.5 atomic %, Ni: 13.7 atomic %, and Mo: 1.9 atomic %.

An actual coupon composition after printing was found to be Fe: 49.1 atomic %, Co: 15.1 atomic %, Cr: 17.8 atomic %, Ni: 16.1 atomic %, and Mo: 2.0 atomic %.

A difference between the target composition and the actual composition was Fe: 1.6 atomic %, Co: 2.2 atomic %, Cr: 1.3 atomic %, Ni: 2.4 atomic %, and Mo: 0.1 atomic %, with almost no error to perform in-situ alloying.

### Example 24

Supply amounts of a first powder, a second powder, and a third powder were adjusted to ratios of 20%, 30%, and 50%, respectively, to manufacture a coupon through in-situ alloying.

A target composition before printing was set to Fe: 53.5 atomic %, Co: 20.4 atomic %, Cr: 13.9 atomic %, Ni: 10.3 atomic %, and Mo: 1.9 atomic %.

An actual coupon composition after printing was found to be Fe: 51.0 atomic %, Co: 17.2 atomic %, Cr: 16.0 atomic %, Ni: 13.7 atomic %, and Mo: 2.0 atomic.

A difference between the target composition and the actual composition was Fe: 2.5 atomic %, Co: 3.2 atomic %, Cr: 2.1 atomic %, Ni: 3.4 atomic %, and Mo: 0.1 atomic %, with almost no error to perform in-situ alloying.

### Example 25

Supply amounts of a first powder, a second powder, and a third powder were adjusted to ratios of 10%, 60%, and 30%, respectively, to manufacture a coupon through in-situ alloying.

A target composition before printing was set to Fe: 44.8 atomic %, Co: 11.7 atomic %, Cr: 22.2 atomic %, Ni: 20.4 atomic %, and Mo: 0.9 atomic %.

An actual coupon composition after printing was found to be Fe: 43.4 atomic %, Co: 9.5 atomic %, Cr: 23.5 atomic %, Ni: 22.5 atomic %, and Mo: 1.1 atomic %.

A difference between the target composition and the actual composition was Fe: 1.4 atomic %, Co: 2.2 atomic %, Cr: 1.3 atomic %, Ni: 2.1 atomic %, and Mo: 0.2 atomic %, with almost no error to perform in-situ alloying.

### Example 26

Supply amounts of a first powder, a second powder, and a third powder were adjusted to ratios of 10%, 50%, and 40%, respectively, to manufacture a coupon through in-situ alloying.

A target composition before printing was set to Fe: 47.6 atomic %, Co: 14.8 atomic %, Cr: 19.7 atomic %, Ni: 17.0 atomic %, and Mo: 0.9 atomic %.

An actual coupon composition after printing was found to be Fe: 45.3 atomic %, Co: 11.9 atomic %, Cr: 21.8 atomic %, Ni: 20.2 atomic %, and Mo: 0.9 atomic %.

A difference between the target composition and the actual composition was Fe: 2.3 atomic %, Co: 2.9 atomic %, Cr: 2.1 atomic %, Ni: 3.2 atomic %, and Mo: 0 atomic %, with almost no error to perform in-situ alloying.

### Example 27

Supply amounts of a first powder, a second powder, and a third powder were adjusted to ratios of 10%, 40%, and 50%, respectively, to manufacture a coupon through in-situ alloying.

A target composition before printing was set to Fe: 50.4 atomic %, Co: 18.0 atomic %, Cr: 17.1 atomic %, Ni: 13.6 atomic %, and Mo: 0.9 atomic %.

An actual coupon composition after printing was found to be Fe: 50.2 atomic %, Co: 17.1 atomic %, Cr: 17.1 atomic %, Ni: 14.5 atomic %, and Mo: 1.1 atomic %.

A difference between the target composition and the actual composition was Fe: 0.2 atomic %, Co: 0.9 atomic %, Cr: 0 atomic %, Ni: 0.9 atomic %, and Mo: 0.2 atomic %, with almost no error to perform in-situ alloying.

The manufactured 27 medium-entropy alloys include Fe: 44 to 60.9 atomic %, Co: 9.3 to 24 atomic %, Cr: 4.3 to 23.5 atomic %, Ni: 3.9 to 22.5 atomic %, and Mo: 0.9 to 8.4 atomic %.

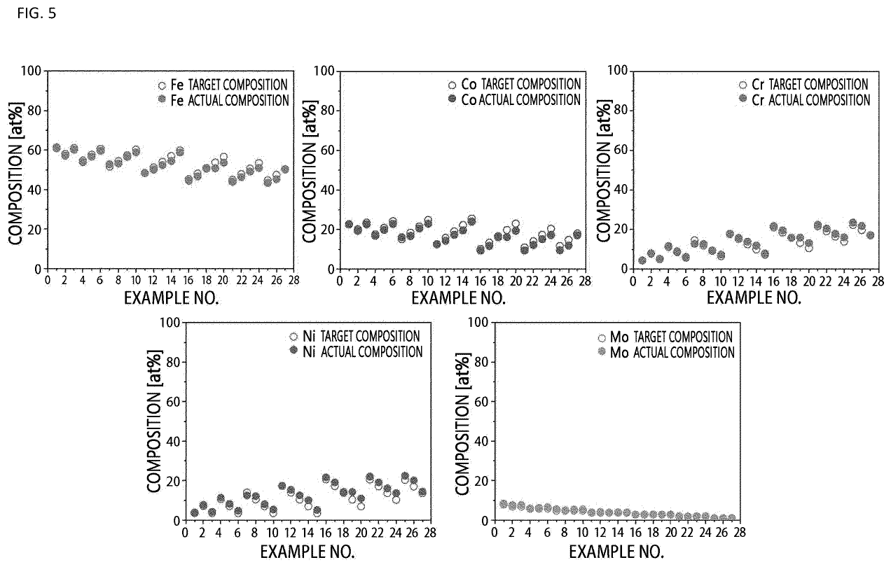

Table 2 below shows printed compositions, and FIG. 5 shows in-situ alloying performed with almost no error from target compositions.

TABLE 2

Actual atomic composition (atomic %)

| | Fe | Co | Cr | Ni | Mo |
|---|---|---|---|---|---|
| Example 1 | 60.9 | 22.5 | 4.3 | 3.9 | 8.4 |
| Example 2 | 57.2 | 19.4 | 8 | 7.8 | 7.6 |
| Example 3 | 60.2 | 22.6 | 5.1 | 4.3 | 7.7 |
| Example 4 | 53.9 | 16.8 | 11.7 | 11.5 | 6 |
| Example 5 | 56.7 | 19.8 | 9 | 8.3 | 6.2 |
| Example 6 | 59.7 | 22.8 | 6.1 | 4.8 | 6.6 |
| Example 7 | 52.9 | 16.1 | 12.8 | 12.5 | 5.6 |
| Example 8 | 53.2 | 16.7 | 12.7 | 12.2 | 5.1 |
| Example 9 | 56.6 | 20.5 | 9.4 | 8.1 | 5.4 |
| Example 10 | 58.9 | 22.9 | 7.3 | 5.4 | 5.5 |
| Example 11 | 48.4 | 12.5 | 17.6 | 17.5 | 4 |
| Example 12 | 50.2 | 14.3 | 15.8 | 15.4 | 4.2 |
| Example 13 | 52.4 | 17.3 | 13.9 | 12.6 | 3.9 |
| Example 14 | 54.5 | 19.5 | 11.9 | 10.1 | 4 |
| Example 15 | 58.8 | 24 | 7.9 | 5.2 | 4 |
| Example 16 | 44.5 | 9.3 | 21.7 | 21.7 | 2.8 |
| Example 17 | 46.7 | 11.7 | 19.6 | 19.2 | 2.9 |
| Example 18 | 50.7 | 16.1 | 15.8 | 14.3 | 3 |
| Example 19 | 50.8 | 16.2 | 15.9 | 14.3 | 2.9 |
| Example 20 | 53.6 | 19.4 | 13.2 | 11 | 2.9 |
| Example 21 | 44 | 9.4 | 22.4 | 22.1 | 2.1 |
| Example 22 | 46.3 | 12.2 | 20.5 | 19.2 | 1.7 |
| Example 23 | 49.1 | 15.1 | 17.8 | 16.1 | 2 |
| Example 24 | 51 | 17.2 | 16 | 13.7 | 2 |
| Example 25 | 43.4 | 9.5 | 23.5 | 22.5 | 1.1 |
| Example 26 | 45.3 | 11.9 | 21.8 | 20.2 | 0.9 |
| Example 27 | 50.2 | 17.1 | 17.1 | 14.5 | 1.1 |

### X-Ray Diffraction Analysis Results

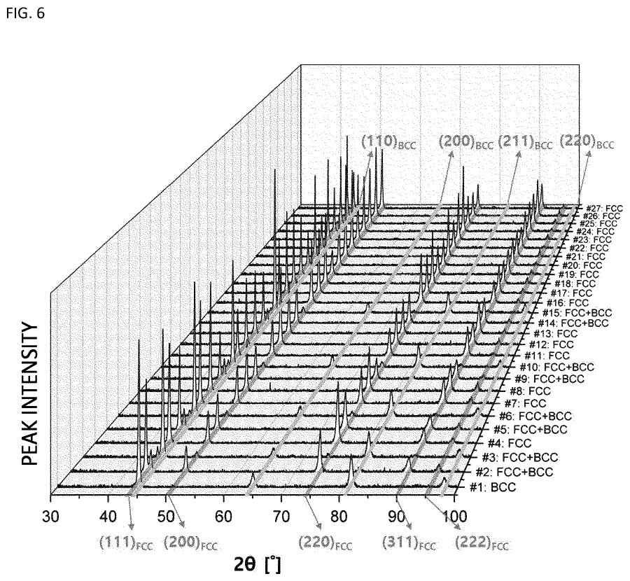

FIG. 6 shows X-ray diffraction measurement results at room temperature for Examples 1 to 27 manufactured. X-ray diffraction measurements were conducted after polishing specimens in the order of sandpaper #400, #600, #800, and #1200 to prevent surface contamination.

Consequently, as determined in FIG. 6, Example 1, which had the lowest Ni composition, was observed to exhibit a single body centered cubic structure. Ni is a well-known face centered cubic structure stabilizing element, and as the composition of this element decreases, the stability of the face centered cubic structure tends to decrease.

Examples 2, 3, 5, 6, 9, 10, 14, and 15, which had relatively low Ni content, were observed to exhibit a mixture of a face centered cubic structure and a body centered cubic structure.

Meanwhile, the remaining 18 Examples, excluding Example above, were observed to exhibit a single face centered cubic structure.

### Vickers Hardness Analysis Results

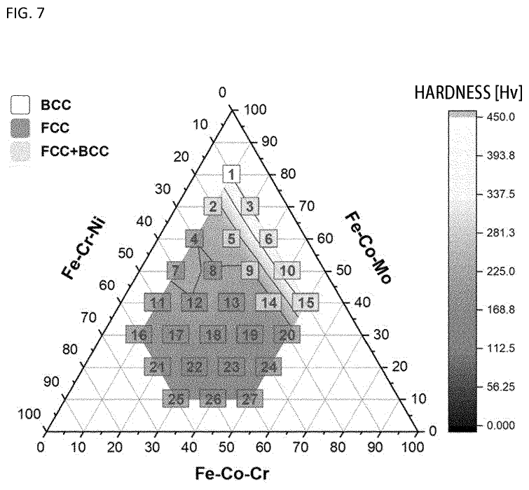

FIG. 7 is a graph that specifies Vickers hardness and shows the degree of Vickers hardness.

Vickers hardness measurements were taken three times for 15 seconds at a force of 500 gf, considering positional deviation, and then averaged out to show values.

Consequently, as determined in FIG. 7, it was observed that the higher the fraction of the body centered cubic structure, the higher the hardness.

Table 3 summarizes the observed values from each of the three measurements, their averages, and standard deviations.

TABLE 3

| | Vickers hardness | Average | Standard |
|---|---|---|---|
| | (Hv) | value | deviation |
| Example 1 | 402.0 | 400.1 | 3.0 |
| | 401.6 | | |
| | 396.7 | | |
| Example 2 | 247.0 | 251.4 | 4.0 |
| | 254.6 | | |
| | 252.7 | | |
| Example 3 | 400.6 | 397.1 | 10.9 |
| | 405.9 | | |
| | 384.9 | | |
| Example 4 | 228.9 | 225.8 | 8.5 |
| | 232.3 | | |
| | 216.3 | | |
| Example 5 | 251.8 | 244.0 | 8.2 |
| | 235.4 | | |
| | 244.7 | | |
| Example 6 | 404.9 | 389.7 | 13.3 |
| | 383.9 | | |
| | 380.3 | | |
| Example 7 | 235.4 | 232.3 | 4.0 |
| | 227.8 | | |
| | 233.6 | | |
| Example 8 | 232.0 | 221.4 | 12.7 |
| | 224.9 | | |
| | 207.4 | | |
| Example 9 | 242.2 | 221.1 | 18.5 |
| | 212.9 | | |
| | 208.1 | | |
| Example 10 | 377.7 | 376.4 | 9.8 |
| | 366.0 | | |
| | 385.6 | | |
| Example 11 | 203.1 | 208.7 | 9.5 |
| | 203.4 | | |
| | 219.7 | | |
| Example 12 | 216.3 | 223.3 | 8.2 |
| | 232.3 | | |
| | 221.3 | | |
| Example 13 | 203.2 | 206.9 | 4.0 |
| | 211.2 | | |
| | 206.3 | | |
| Example 14 | 204.9 | 201.9 | 6.6 |
| | 194.4 | | |
| | 206.4 | | |
| Example 15 | 358.8 | 354.0 | 4.2 |
| | 351.6 | | |
| | 351.6 | | |
| Example 16 | 187.3 | 193.2 | 8.9 |
| | 188.7 | | |
| | 203.4 | | |
| Example 17 | 197.3 | 193.0 | 5.1 |
| | 194.4 | | |
| | 187.3 | | |
| Example 18 | 190.1 | 192.7 | 9.6 |
| | 184.7 | | |
| | 203.3 | | |
| Example 19 | 179.4 | 175.1 | 12.3 |
| | 184.7 | | |
| | 161.3 | | |
| Example 20 | 186.0 | 188.8 | 3.7 |
| | 187.4 | | |
| | 193.0 | | |
| Example 21 | 191.5 | 194.4 | 2.9 |
| | 197.3 | | |
| | 194.4 | | |
| Example 22 | 141.7 | 171.6 | 26.0 |
| | 186.0 | | |
| | 187.3 | | |
| Example 23 | 173.1 | 180.4 | 8.7 |
| | 190.0 | | |
| | 178.0 | | |
| Example 24 | 171.6 | 177.4 | 5.0 |
| | 180.3 | | |
| | 180.3 | | |
| Example 25 | 191.2 | 180.7 | 9.2 |
| | 174.2 | | |
| | 176.6 | | |
| Example 26 | 173.0 | 178.0 | 6.8 |
| | 185.8 | | |
| | 175.2 | | |
| Example 27 | 175.4 | 171.4 | 4.9 |
| | 172.8 | | |
| | 165.9 | | |

Thus, through the method for manufacturing a medium-entropy alloy according to the invention, alloy products having various compositions and properties without limitation simply by adjusting the spray amount of plural alloy powders.

A method for manufacturing a medium-entropy alloy according to the invention enables the process-efficient manufacturing of alloy products having various compositions, thereby enabling screening of various compositions during the development process and facilitating the production of various types of products.

What is claimed is:

1. A method for manufacturing a medium-entropy alloy through additive manufacturing,
wherein the additive manufacturing is performed by spraying and heating two or more alloy powders having different compositions, and
the alloy powders contain two or more alloy elements, and a difference between a maximum melting point and a minimum melting point among melting points of each of the two or more alloy powders is 400° C. or less.

2. The method according to claim 1,
wherein the difference between the maximum melting point and the minimum melting point is less than 120° C.

3. The method according to claim 1,
wherein the medium-entropy alloy comprises 44 to 60.9 atomic % of Fe, 9.3 to 24 atomic % of Co, 4.3 to 23.5 atomic % of Cr, 3.9 to 22.5 atomic % of Ni, 0.9 to 8.4 atomic % of Mo, and other inevitable impurities.

4. The method according to claim 3,
wherein the two or more alloy powders comprise first to third alloy powders, the first alloy powder comprises Fe, Co, and Mo, the second alloy powder comprises Fe, Cr, and Ni, and the third alloy powder comprises Fe, Co, and Cr.

5. The method according to claim 4,
wherein the first alloy powder has a melting point of 1,400 to 1,420° C., the second alloy powder has a melting point of 1,390 to 1,410° C., and the third alloy powder has a melting point of 1,490 to 1,510° C.

6. The method according to claim 1,
wherein the heating is performed via laser or electron beam.

7. The method according to claim 1,
wherein the medium-entropy alloy manufactured through the additive manufacturing has a hardness of 170 to 410 Hᵥ in Vickers hardness.
